(19) United States
(12) Patent Application Publication
(10) Pub. No.: US 2025/0095493 A1
(43) Pub. Date: Mar. 20, 2025

(54) Method for Finding an Emergency Parking Position for a Motor Vehicle

(71) Applicant: Robert Bosch GmbH, Stuttgart-Feuerbach (DE)

(72) Inventors: Dr. Stefan Nordbruch, Leonberg (DE); Manfred Harrer, Gumpoldskirchen (AT)

(73) Assignee: Robert Bosch GmbH, Stuttgart-Feuerbach (DE)

(21) Appl. No.: 18/961,899

(22) Filed: Nov. 27, 2024

Related U.S. Application Data
(63) Continuation of application No. PCT/EP2023/064557, filed on May 31, 2023.

(30) Foreign Application Priority Data
May 31, 2022 (DE) 10 2022 113 743.0

(51) Int. Cl. G08G 1/14; B60W 50/00; B64U 10/13; B64U 101/20; G08G 1/01

(52) U.S. Cl. CPC G08G 1/141; B60W 50/0098; B64U 10/13; G08G 1/0112; B64U 2101/20

(57) ABSTRACT

A method for finding an emergency parking position for safe parking of a motor vehicle includes generating a plurality of control signals for controlling a drone having a monitoring facility. The control signals are output to control the drone to monitor an environment of the motor vehicle using the monitoring facility and to output a monitoring data based on the monitoring. After outputting the control signals, the monitoring data is received from the drone, the monitoring data is analyzed to find an emergency parking position for safe parking of the motor vehicle in an emergency, and an analysis result of the analysis of the monitoring data is output.

### CROSS-REFERENCE TO RELATED APPLICATIONS

This application is a continuation of PCT International Application No. PCT/EP2023/064557, filed on May 31, 2023, which claims priority under 35 U.S.C. § 119 to German Patent Application DE 10 2022 113 743.0, filed on May 31, 2022.

### FIELD OF THE INVENTION

The invention relates to a method for finding an emergency parking position for safe parking of a motor vehicle in an emergency, a system for finding an emergency parking position for safe parking of a motor vehicle in an emergency, an apparatus, a computer program, and a machine-readable storage medium.

### BACKGROUND

The published patent application DE 10 2016 215 301 A1 discloses a method for supporting a parking process of a vehicle using a drone.

The published patent application DE 10 2020 005 596 A1 discloses a method for rear area monitoring using an unmanned aerial vehicle.

The patent U.S. Pat. No. 9,371,133 B2 discloses a drone system for supporting a reversing of a truck.

The published patent application US 2019/0227555 A1 discloses a method and system for assisting a vehicle while traveling on a road using a drone.

The published patent application US 2020/0005642 A1 discloses a method for moving a parked vehicle for an emergency response vehicle using a drone.

The published patent application US 2020/0285255 A1 discloses a method for warning a cyclist of a moving vehicle using a drone.

The published patent application US 2021/0064020 A1 discloses a method for controlling a vehicle using a drone.

### SUMMARY

A method for finding an emergency parking position for safe parking of a motor vehicle includes generating a plurality of control signals for controlling a drone having a monitoring facility. The control signals are output to control the drone to monitor an environment of the motor vehicle using the monitoring facility and to output a monitoring data based on the monitoring. After outputting the control signals, the monitoring data is received from the drone, the monitoring data is analyzed to find an emergency parking position for safe parking of the motor vehicle in an emergency, and an analysis result of the analysis of the monitoring data is output.

### BRIEF DESCRIPTION OF THE DRAWINGS

The invention is explained in more detail below with reference to embodiments. In the drawings:

FIG. 1 shows a flow chart of a method according to a first aspect;

FIG. 2 shows an apparatus according to a second aspect;

FIG. 3 shows a system according to a third aspect;

FIG. 4 shows a machine-readable storage medium according to a fifth aspect; and

FIG. 5 shows a schematic diagram of a tunnel.

### DETAILED DESCRIPTION OF THE EMBODIMENT(S)

According to the present disclosure, one or more drones are used to find a suitable emergency parking position at which a motor vehicle can safely park itself in an emergency. The at least one drone, i.e., the one or more drones, are controlled in such a way that they monitor the environment of the motor vehicle using their respective monitoring facility and output monitoring data based on the monitoring. This means that knowledge about the environment is available in an advantageous and efficient manner. This knowledge is used to search for suitable emergency parking positions where the motor vehicle can be safely parked in an emergency.

The fact that one or more drones are used for this purpose has the technical advantage that a monitoring facility of a drone can also monitor areas in the environment of the motor vehicle which the motor vehicle cannot monitor using its own environmental sensor or its own environmental sensors. For example, an own environmental sensor of the motor vehicle has a certain range. The drone, on the other hand, can be controlled in such a way that it monitors an area of the environment of the motor vehicle which are outside the range of the environmental sensor in the motor vehicle. This means that information about the environment of the motor vehicle is available which would not be available when the motor vehicle uses its own environmental sensors.

Thus, the technical advantage is that it is possible to search efficiently for one or more suitable emergency parking positions so that, as a result, emergency parking positions in the environment of the motor vehicle can also be found efficiently, which could not be found when the motor vehicle uses its own environmental sensor. A concept is thus provided for efficiently finding an emergency parking position for safe parking of a motor vehicle in an emergency.

Parking means that the motor vehicle is stopped from travelling, i.e., from moving. This means that the motor vehicle for which an emergency parking position is sought or for which an emergency parking position is to be found is a moving motor vehicle or a vehicle in motion. The phrase “for safe parking of a motor vehicle” can therefore be supplemented as follows, for example: “for safe parking of a travelling motor vehicle” or “for safe parking of a moving motor vehicle.” In this way, it is always possible in the case of the motor vehicle to understand that the motor vehicle is travelling or is moving, i.e., that it is a travelling or moving motor vehicle. The motor vehicle therefore has a speed greater than 0 km/h in particular. The motor vehicle is therefore not at a standstill, i.e., it is not already parked.

The wording “to park” therefore makes it clear that the motor vehicle is currently travelling, i.e., moving and is not already parked. This is because a parked motor vehicle cannot be parked again. In particular, this means that at the point in time or points in time at which an emergency parking position for the motor vehicle is searched for based on the monitoring data in accordance with the concept described here, the motor vehicle is travelling, i.e., is moving, and is not already parked.

The monitoring data is therefore analyzed in particular in order to find an emergency parking position for safe parking of the moving or travelling motor vehicle in an emergency.

An emergency or an emergency situation is, in particular, a situation in which there is an imminent danger to property, in particular the motor vehicle, animals or the physical integrity of people, in particular the occupants of the motor vehicle. An emergency or an emergency situation is in particular a situation in which the motor vehicle has a malfunction, i.e., in which a component and/or a system of the motor vehicle has a malfunction. A system of the motor vehicle is, for example, a driver assistance system. An emergency or an emergency situation is, in particular, a situation in which an at least partially automated driving function of the motor vehicle exhibits a fault. The terms “emergency” and “emergency situation” can be used synonymously.

If the singular is used for the drone in the description, the plural should always be understood and vice versa. Statements made in connection with one drone apply analogously to multiple drones and vice versa.

The phrase “at least one” means “one or more.” This means in particular that, for example, multiple drones can be used. Multiple drones are, for example, identical or are, for example, different.

The monitoring facilities of the drones are, for example, at least partially, in particular all, identical or are, for example, at least partially, in particular all, different.

A monitoring facility within the meaning of the description comprises, for example, one or more environmental sensors. This means in particular that the drone has one or more environmental sensors, for example. In particular, the drone is therefore equipped with one or more environmental sensors.

An environmental sensor of a monitoring facility detects, for example, an environment of the motor vehicle and outputs environmental sensor data based on this detection. Such environmental sensor data is, for example, included in the monitoring data. This means that monitoring within the meaning of the description comprises detecting an environment of the motor vehicle using an environmental sensor of the monitoring facility.

If the singular is used for the environmental sensor, the plural should always be understood and vice versa. Statements made in connection with one environmental sensor apply analogously to multiple environmental sensors and vice versa.

An environmental sensor in the sense of the description is, for example, one of the following environmental sensors: LiDAR sensors, radar sensor, image sensor, in particular image sensor of a video camera or a stereo camera, ultrasound sensor, infrared sensor and magnetic field sensor. Environmental sensors can, for example, be identical or can, for example, be different.

In one embodiment of the method, the method comprises a step of controlling the at least one drone based on the output control signals.

In one embodiment of the method, the method comprises a step of monitoring the environment of the motor vehicle using at least one drone.

In one embodiment of the method, the method comprises a step of detecting the environment of the motor vehicle using an environmental sensor of the monitoring facility.

In one embodiment of the method, the method comprises a step of wirelessly transmitting the output control signals to the at least one drone. Such wireless transmission comprises, for example, transmission of the control signals via a wireless communication network, for example a cellular network and/or WLAN network.

The process of receiving the monitoring data comprises, for example, a process of wirelessly receiving the monitoring data, in particular wirelessly receiving the monitoring data via a wireless communication network, for example a cellular network and/or a WLAN network.

In one embodiment of the method, the method is a computer-implemented method.

The embodiments and exemplary embodiments described in the description can be combined with each other in any form, even if this is not explicitly described.

The analysis result indicates, for example, whether an emergency parking position has been found or not. If an emergency parking position is found, the analysis result indicates the position of the found emergency parking position, for example.

For example, multiple emergency parking positions can be found. Statements made in connection with an emergency parking position apply analogously to multiple emergency parking positions and vice versa.

Analyzing the monitoring data comprises, for example, processing the monitoring data. The processing of the monitoring data is carried out, for example, using a processor or using multiple processors. This means, for example, that the analyzing can be performed using a computer or using multiple computers.

In one embodiment of the method, it is provided that the analyzing comprises determining a hazard level for a found emergency parking position, which indicates how endangered the motor vehicle would be in the found emergency parking position and/or how endangered an environment of the found emergency parking position would be if the motor vehicle were parked in the found emergency parking position.

This results, for example, in the technical advantage that it is possible to efficiently estimate the extent to which the motor vehicle would endanger itself if it were parked in the found emergency parking position and/or the extent to which an environment of the found emergency parking position would be endangered if the motor vehicle were parked in the found emergency parking position.

The hazard level indicates, for example, a risk of collision between the motor vehicle and one or more road users in the environment or in the vicinity of the motor vehicle if the motor vehicle were parked in the emergency parking position. A road user is, for example, one of the following road users: pedestrian, motor vehicle, motorcycle, cyclist.

The hazard, i.e., how endangered the motor vehicle and/or an environment of the found emergency parking position would be if the motor vehicle were parked in the found emergency parking position, is therefore quantified in particular by the hazard level.

In one embodiment of the method, it is provided that dimension signals are received which represent one or more dimensions of the motor vehicle, wherein the monitoring data is analyzed based on the dimension signals, wherein the analyzing comprises that a found emergency parking position is checked as to whether the motor vehicle can be parked in the found emergency parking position due to its dimension or dimensions. This has the technical advantage, for example, that a found emergency parking position can be efficiently checked for its suitability as to whether the motor vehicle even fits into the found emergency parking position due to its size, i.e., due to its dimensions. A dimension is, for example, one of the following dimensions: length, width, height.

In one embodiment of the method, it is provided that the analyzing comprises checking that a found emergency parking position can be approached by the motor vehicle. This has the technical advantage, for example, that it can be efficiently ensured that a found emergency parking position can actually be approached by the motor vehicle, i.e., that the motor vehicle can actually approach the found emergency parking position.

Checking whether a found emergency parking position can be approached by the motor vehicle at all comprises, for example, checking whether an entrance to the emergency parking position, in particular an entrance to a lay-by, is wide enough for the motor vehicle to drive through the entrance, and/or checking whether one or more objects are located in front of the emergency parking position, for example a roadwork's marking or a pillar, for example a roadwork's pillar, which could obstruct or prevent entry into the emergency parking position, and/or checking whether an entry radius required for the motor vehicle to enter the emergency parking position is possible due to a maximum possible steering angle of the motor vehicle.

In one embodiment of the method, it is provided that error signals are received which represent an error in an at least partially automated driving function of the motor vehicle, wherein the monitoring data is analyzed based on the error signals, wherein the analyzing comprises checking whether despite the error in the at least partially automated driving function the found emergency parking position can be approached by the motor vehicle in an at least partially automated manner. This results, for example, in the technical advantage that it can be efficiently ensured that the motor vehicle can drive to a found emergency parking position in an at least partially automated manner.

An error can include, for example, a failure of one or more of the environmental sensors in the motor vehicle. For example, it can be checked whether the found emergency parking position can be approached in an at least partially automated manner despite the failure.

Checking whether the found emergency parking position for the motor vehicle can be approached in an at least partially automated manner despite the error in the at least partially automated driving function comprises, for example, checking whether the found emergency parking position for the motor vehicle can be approached in an at least partially automated manner with limited functionality. Limited functionality includes, for example, driving at a lower speed than if the at least partially automated driving function has no error. This means, for example, that the found emergency parking position can still be approached at least in a partially automated manner, albeit at a lower speed.

The phrase “at least partially automated driving” includes one or more of the following cases: assisted driving, partially automated driving, highly automated driving, fully automated driving. The phrase “at least partially automated” therefore includes one or more of the following formulations: assisted, partially automated, highly automated, fully automated.

Assisted driving means that a driver of the motor vehicle permanently performs either the lateral or longitudinal control of the motor vehicle. The other driving task (i.e., controlling the longitudinal or lateral guidance of the motor vehicle) is performed in an automated manner. This means that either the lateral or longitudinal guidance is controlled in an automated manner during assisted driving of the motor vehicle.

Partially automated driving means that in a specific situation (for example: driving on a highway, driving within a parking lot, overtaking an object, driving within a lane defined by lane markings) and/or for a certain period of time, longitudinal and lateral guidance of the motor vehicle are controlled in an automated manner. A driver of the motor vehicle does not have to manually control the longitudinal and lateral guidance of the motor vehicle. However, the driver must permanently monitor the automated control of the longitudinal and lateral guidance in order to be able to intervene manually if necessary. The driver must be ready to take full control of the motor vehicle at all times.

Highly automated driving means that, for a certain period of time in a specific situation (for example: driving on a highway, driving within a parking lot, overtaking an object, driving within a lane defined by lane markings), longitudinal and lateral guidance of the motor vehicle are controlled in an automated manner. A driver of the motor vehicle does not have to manually control the longitudinal and lateral guidance of the motor vehicle themselves. The driver does not have to continuously monitor the automated control of the longitudinal and lateral guidance in order to be able to intervene manually if necessary. If necessary, a takeover request is automatically issued to the driver to take over control of the longitudinal and lateral guidance, in particular with a sufficient time reserve. The driver must therefore potentially be able to take control of the longitudinal and lateral guidance. The limits of automated control of the lateral and longitudinal guidance are recognized automatically. With highly automated driving, it is not possible to automatically bring about a state of minimum risk in every initial situation.

Fully automated guidance means that in a specific situation (for example: driving on a highway, driving within a parking lot, overtaking an object, driving within a lane defined by lane markings), a longitudinal and a lateral guidance of the motor vehicle are controlled in an automated manner. A driver of the motor vehicle does not have to manually control the longitudinal and lateral guidance of the motor vehicle themselves. The driver does not have to monitor the automated control of the longitudinal and lateral guidance in order to be able to intervene manually if necessary. Before the automated control of the lateral and longitudinal guidance is terminated, the driver is automatically prompted to take over the driving task (control of the lateral and longitudinal guidance of the motor vehicle), in particular with a sufficient time reserve. If the driver does not take over the driving task, the system automatically returns to a state that minimizes risk. The limits of automated control of the lateral and longitudinal guidance are recognized automatically. In all situations, it is possible to automatically return to a system state that minimizes risk.

In one embodiment of the method, it is provided that emergency route signals are generated which represent an emergency route from a start position to a found emergency parking position for the motor vehicle, wherein the generated emergency route signals are output. This has the technical advantage, for example, that the motor vehicle can be efficiently guided to the found emergency parking position. In particular, the determined emergency route is thus specified to the motor vehicle, based on which the motor vehicle can drive to the found emergency parking position.

The start position is, for example, the current position of the motor vehicle or is, for example, a future position of the motor vehicle. The future position of the motor vehicle can, for example, be predicted.

In one embodiment of the method, it is provided that the analyzing comprises determining the optimum emergency parking position if multiple emergency parking positions are found. This has the technical advantage, for example, that it can be efficiently ensured that an optimum emergency parking position is found for the motor vehicle with regard to safe parking.

An optimum emergency parking position is, for example, the closest emergency parking position relative to the motor vehicle and to a direction of travel of the motor vehicle. An optimum emergency parking position is, for example, the one of the emergency parking positions found that offers the most space for parking the motor vehicle. An optimum emergency parking position is, for example, the one of the emergency parking positions found that offers the best accessibility for parking the motor vehicle. Best can mean, for example, that there are no objects that obstruct or prevent the motor vehicle from entering the emergency parking position. Best can mean, for example, additionally or instead, that the required entry radius is minimal in relation to the required entry radii of the other emergency parking positions.

In one embodiment of the method, it is provided that route signals are received which represent a current route of the motor vehicle based on which the motor vehicle is currently driving, wherein the control signals are generated based on the route signals and/or wherein the monitoring data is analyzed based on the route signals. This results, for example, in the technical advantage that the control signals can be generated efficiently and/or that the monitoring data can be analyzed efficiently.

According to this embodiment, knowledge of where the motor vehicle wants to go is therefore available. Accordingly, the drone can be instructed by the control signals as to which area in the environment of the motor vehicle the drone is to monitor using its monitoring facility, so that the drone then also monitors this area using its monitoring facility in accordance with the control signals. For example, the drone is instructed by the control signals to monitor an area in the environment of the motor vehicle which is located in front of the motor vehicle in the direction of travel according to the current route of the motor vehicle.

If it is known where the motor vehicle wants to go, the area in front of the motor vehicle in the direction of travel of the current route can also be analyzed for possible emergency parking positions so that the monitoring data can be analyzed efficiently.

According to one embodiment of the method, it is provided that environmental signals are received which represent the environment of the motor vehicle, wherein the control signals are generated based on the environmental signals and/or wherein the monitoring data is analyzed based on the environmental signals. This results, for example, in the technical advantage that the control signals can be generated efficiently and/or that the monitoring data can be analyzed efficiently.

According to this embodiment, additional knowledge about the environment of the motor vehicle is therefore available, which can be used together with the monitoring data in order to search for suitable emergency parking positions and find them accordingly. If additional knowledge about the environment of the motor vehicle is available, the drone can be controlled efficiently and advantageously so that it does not collide with infrastructure objects, for example. An infrastructure object is, for example, a building, a traffic light system, a mast, or a traffic sign. Objects with which the drone could collide include, for example, vegetation such as trees and/or bushes. Knowledge of such vegetation can, for example, also be represented by the environmental signals.

In one embodiment of the method, it is provided that the environmental signals comprise environmental signals transmitted by another motor vehicle which is located in front of the motor vehicle with respect to a direction of travel of the motor vehicle. This has the technical advantage, for example, that particularly suitable environmental signals can be used for generating the control signals and/or for analyzing the monitoring data. According to this embodiment, the additional knowledge about the environment of the motor vehicle is thus provided by a further motor vehicle which detects its own environment using its own motor vehicle environmental sensor or its own motor vehicle environmental sensors, wherein this own environment is naturally encompassed by the environment of the motor vehicle, so that corresponding knowledge about the environment of the motor vehicle, which is located in the direction of travel, can be provided in an efficient manner.

In one embodiment of the method, it is provided that the environmental signals include map signals which represent a digital map of the environment of the motor vehicle. This has the technical advantage, for example, that particularly suitable environmental signals can be used for generating the control signals and/or for analyzing the monitoring data. According to this embodiment, a digital map of the environment of the motor vehicle is therefore provided.

In one embodiment of the method, it is envisaged that one, multiple or all of the method steps are carried out by the motor vehicle and/or by the infrastructure and/or by the drone. This has the technical advantage, for example, that the individual method steps can be carried out efficiently.

In one embodiment of the method, it is provided that the method is not started until an emergency occurs or that the method is started proactively even before an emergency occurs. This has the technical advantage, for example, that the method can be carried out efficiently. The proactive embodiment has the advantage, for example, that an emergency parking position can be approached if it is determined that although there is currently no emergency, one will occur in the foreseeable future, in particular with a predetermined probability in the foreseeable future. Whether an emergency will occur in the near future can be determined, for example, based on diagnostic data from the motor vehicle. In this way, for example, subsequent faults and/or vehicle damage and/or vehicle defects that may result from an emergency can be avoided or at least reduced in their severity.

If the method is only started in an emergency, the resources required for the method, in particular computing resources, can be used efficiently in an advantageous way. For example, the energy storage facility in the drone can be used efficiently. This is because it is only started, for example, when an emergency has occurred.

In one embodiment of the method, it is provided that, based on the analysis result, infrastructure assistance data for infrastructure-supported assistance of the motor vehicle during an at least partially automated guided journey to a found emergency parking position is determined and transmitted to the motor vehicle. This has the technical advantage, for example, that the infrastructure assistance data can be determined efficiently.

Infrastructure assistance data comprises, for example, a recommendation for action for the motor vehicle and/or includes, for example, remote control commands for remotely controlling lateral and/or longitudinal guidance of the motor vehicle. Infrastructure assistance data comprises, for example, the analysis result. Infrastructure assistance data comprises, for example, the determined emergency route from the start position to the found emergency parking position.

In one embodiment of the method, it is provided that motor vehicle control signals for at least partially automated control of lateral and/or longitudinal guidance of the motor vehicle are generated and output based on the analysis result. This has the technical advantage, for example, that the motor vehicle control signals can be generated efficiently.

In one embodiment of the method, the method comprises a step of controlling a lateral and/or longitudinal guidance of the motor vehicle based on the output motor vehicle control signals.

In one embodiment of the method, it is provided that the control signals are generated such that, when controlling the drone based on the generated control signals, the monitoring of the environment comprises monitoring road traffic in the environment of the motor vehicle. This has the technical advantage, for example, that road traffic in the vicinity of the motor vehicle can be monitored efficiently. This additional information can advantageously be used to determine the route from the start position to the found emergency parking position, and/or can advantageously be used, for example, to find a suitable emergency parking position, and/or can be used, for example, to determine the hazard level.

In one embodiment of the method, it is provided that the monitoring data and/or the analysis result are transmitted to a traffic control center. This results, for example, in the technical advantage that the traffic control center is efficiently enabled to plan one or more actions based on the analysis result and/or based on the monitoring data and, for example, to control and/or coordinate them accordingly.

In one embodiment of the method, it is provided that, in the event of an emergency, a message is transmitted to one or more road users in the vicinity of the motor vehicle, informing them of the emergency and/or of the found emergency parking position and/or of an operation for parking the motor vehicle at the found emergency parking position. This results, for example, in the technical advantage that the one or more road users can be efficiently informed about the emergency and/or about the found emergency parking position and/or about an operation of parking the motor vehicle at the found emergency parking position. Accordingly, these road users can react to this in an efficient manner.

In one embodiment of the method, it is provided that the control signals are generated such that, when controlling the drone based on the generated control signals, the monitoring of the environment comprises live monitoring of the environment of the motor vehicle, so that the monitoring data comprises live monitoring data. This has the technical advantage, for example, that the environment of the motor vehicle is monitored efficiently so that suitable emergency parking positions can be found efficiently.

Apparatus features and/or system features result analogously from corresponding method features and vice versa. Statements made in connection with the method and/or the apparatus and/or the system apply analogously to statements made in connection with the system and/or the apparatus and/or the method and vice versa.

In one embodiment, the method is carried out at a critical location. Such a critical

location is, for example, a construction site, a tunnel, a highway entrance, a highway exit. This means in particular that the motor vehicle can be efficiently supported by the at least one drone when driving through such a critical location.

In one embodiment of the method, it is provided that the at least one drone is assigned to the motor vehicle. This means, for example, that the at least one drone belongs to the motor vehicle and is used or deployed by the motor vehicle. This means, for example, that the at least one drone is controlled by the motor vehicle. In particular, this means that the control signals are generated and output by the motor vehicle. The motor vehicle sends the generated and output control signals wirelessly, for example to the at least one drone in order to control it. For example, the at least one drone accompanies the motor vehicle and flies ahead of the motor vehicle, for example in relation to the direction of travel of the motor vehicle. For example, the motor vehicle starts the at least one drone when an error is detected, for example an error in an at least partially automated driving function of the motor vehicle. For example, the motor vehicle launches the at least one drone in an emergency.

In one embodiment of the method, it is provided that the at least one drone is assigned to an infrastructure. This means, for example, that the at least one drone belongs to the infrastructure. For example, the at least one drone is assigned to the critical location, such as a road or a critical road area. This means, for example, that the at least one drone is waiting to be deployed at such a critical location and is then activated accordingly. The at least one drone can, for example, fly continuously and can, for example, also be used for other tasks if it is not currently to be used for the method for finding an emergency parking position according to the first aspect. The control of the at least one drone can, for example, be carried out on the infrastructure side, i.e. by the infrastructure. This means that the control signals are generated and output by the infrastructure. The infrastructure sends the output control signals, for example wirelessly, to the at least one drone. A road management system and/or drone system can be provided within the infrastructure, which takes over this control.

In the embodiment according to which the drone is assigned to the infrastructure, the control can alternatively or additionally also be performed by the motor vehicle.

In one embodiment of the method, it is provided that status signals are received which represent a status of the motor vehicle, wherein the monitoring data is analyzed based on the status signals and/or wherein the control signals are generated based on the status signals. This results, for example, in the technical advantage that the control signals can be generated efficiently and/or that the monitoring data can be analyzed efficiently.

The control signals are generated, for example, using a digital map of the environment of the motor vehicle. The control signals can be generated, for example, based on a current route of the motor vehicle. For example, the control signals for the at least one drone can be generated based on possible routes of the motor vehicle. This means that the control signals can, for example, be generated based on possible routes of the motor vehicle.

The status indicates, for example, a respective functionality of one, multiple or all vehicle components. A motor vehicle component is, for example, one of the following motor vehicle components: drive system, brake system, environmental sensor, transmission, tires, steering system, control unit, in particular control unit for an at least partially automated driving function, driver assistance system, lighting system, actuator, communication interface, in particular mobile radio interface or WLAN interface.

In one embodiment of the method, it is provided that the control signals are generated in such a way that the at least one drone flies along all possible routes of the motor vehicle in relation to the direction of travel of the motor vehicle in front of the motor vehicle and monitors them accordingly using its monitoring facility. This means that, according to this embodiment, it is provided that the at least one drone searches for all possible emergency parking positions in the vicinity of the motor vehicle, which is located in front of the motor vehicle with respect to the direction of travel of the motor vehicle, without, however, knowing the specific route or a specific destination of the motor vehicle.

In one embodiment of the method, it is provided that the at least one drone is provided with or sent known data on road areas, generally on the environment of the motor vehicle. Such known data comprises, for example, data about a road width, a position of emergency bays, position of signs. As a rule, this data comprises data about stationary objects, for example where such an emergency bay is located.

According to one embodiment, the data comprises dynamic data, i.e., information about whether such an emergency bay is occupied or free, for example. The monitoring facility can check whether the bay is actually occupied or not. In general, this known data can be validated by the at least one drone by analyzing and evaluating the monitoring data accordingly.

In one embodiment of the method, it is provided that data from one or more other motor vehicles, which are located in front of the motor vehicle, in particular in relation to the direction of travel of the motor vehicle, are also used. This data is represented, for example, by the environmental signals described here, which are transmitted by another motor vehicle.

In one embodiment of the method, it is provided that the drones are used for a validation of known data, for example from the digital map and/or from the environmental signals which represent the environment of the motor vehicle, wherein these environmental signals are transmitted, for example, by a further motor vehicle which is located in front of the motor vehicle with respect to a direction of travel of the motor vehicle.

In one embodiment of the method, it is provided that the at least one drone is completely controlled by the motor vehicle and/or the infrastructure.

In one embodiment of the method, it is provided that the at least one drone is a smart drone. This means that the at least one drone can autonomously monitor the environment of the motor vehicle or the environment of the motor vehicle. The at least one drone controls itself and acts autonomously.

In one embodiment of the method, it is envisaged that the at least one drone learns with each use, in particular using machine learning methods.

A machine learning method checks, for example, whether a planned goal was achieved during an earlier execution of the method. An example of a goal is that the found emergency parking position was accessible and/or offered sufficient space, i.e., sufficiently large dimensions.

A machine learning method checks, for example, whether the dimensions of the motor vehicle and the determined dimensions of the emergency parking position matched when the method was carried out previously, i.e. whether the motor vehicle fitted into the found emergency parking position at that time or whether the motor vehicle would have needed a larger emergency parking position at that time.

A machine learning method checks, for example, whether a planned target trajectory for safe parking in the found emergency parking position could be at least partially automated by the motor vehicle in an emergency. If not, an algorithm for determining such a target trajectory can be adapted, for example.

A machine learning method simulates, for example, an execution of the method.

A machine learning method uses, for example, data from one or more other motor vehicles and/or drones to determine, for example, one or more optimal control parameters for the drone control, so that in an emergency the control signals for the drone are generated based on the one or more optimal control parameters.

A result or results of a machine learning method are used, for example, in a current execution of the method.

According to one embodiment, the method comprises performing a machine learning method.

In one embodiment of the method, it is envisaged that any combination ranging from a dumb drone up to a smart drone is possible. This means that the at least one drone can be a smart drone but is additionally monitored by the motor vehicle and/or infrastructure side.

In one embodiment of the method, it is provided that the at least one drone is only started after the emergency has been detected, in particular after a fault has been detected in an at least partially automated driving function of the motor vehicle.

In one embodiment of the method, it is provided that at least one drone is already started proactively, in particular via a fault or emergency that may occur shortly.

Communication between the drone and the motor vehicle is, for example, direct communication. This means that data and/or signals can be exchanged directly between the at least one drone and the motor vehicle.

In one embodiment of the method, it is provided that a communication between the drone and the motor vehicle is an indirect communication. This means that data and/or signals are transmitted between the at least one drone and the motor vehicle via an external system, for example a cloud and/or backend system and/or a local parking system or a road management system and/or a drone system.

A backend system comprises, for example, a server system, which is located in an operations center, for example. This means, in particular, that in the case of a backend, for example, a location of the server system is known. A cloud system comprises, for example, a server system whose location is unknown, for example.

The cloud is also a server system where the location may not be known.

In one embodiment of the method, it is envisaged that communication between drones and motor vehicle and infrastructure is a secure connection. This means, for example, that the communication can be secured using certificates, in particular encrypted.

The at least one drone has, for example, a monitoring facility comprising one or more environmental sensors. These environmental sensors are, for example, environmental sensors according to different sensor technologies. For example, these environmental sensors are radar sensors, image sensors and/or LiDAR sensors. For example, in addition to images, other information such as distances and dimensions can also be determined for objects. In particular, this increases safety if multiple environmental sensors are used in the sense of redundancy and different ones in the sense of diversity.

In one embodiment of the method, it is provided that the at least one drone uses its monitoring facility to monitor traffic around the motor vehicle and/or in front of the motor vehicle. This enables the motor vehicle to drive through traffic more easily, particularly in an emergency.

In one embodiment of the method, it is provided that the monitoring data and/or the analysis result and/or, for example, infrastructure assistance data are transmitted to a traffic control center and/or road control center. Such control centers can then, for example, plan further actions. Such further actions include, for example, traffic detour and/or updating of occupancy data for the emergency bay.

An emergency bay can also be referred to as a lay-by. This means, for example, that a lay-by within the meaning of the German Road Traffic Act is such an emergency lay-by.

In one embodiment of the method, it is provided that one or more other road users in the vicinity of the motor vehicle are informed of the current problem situation and/or the parking process. This can, for example, be carried out by the motor vehicle and/or drone and/or infrastructure. This means, for example, that a corresponding message is transmitted wirelessly from the motor vehicle and/or from the infrastructure and/or from the drone to one or more motor vehicles in the vicinity of the motor vehicle, whereby this message informs them accordingly.

In one embodiment of the method, it is provided that the road control center and/or traffic control center and/or road traffic control center is continuously and/or promptly informed about the process. Such a control center can, for example, plan and control and/or coordinate further actions. Such actions include, for example, calling in services or support, for example from the police, fire department and/or towing service. Such an action includes, for example, traffic rescheduling.

If one of the terms road traffic center, road center, traffic center and traffic control center is used, the other terms should always be understood as well. These are used synonymously.

In one embodiment of the method, it is provided that the environment of the motor vehicle is monitored live using the monitoring facility of the at least one drone.

In one embodiment of the method, it is provided that one, multiple or all method steps are documented, in particular documented in a blockchain.

For example, the system according to the third aspect is adapted to perform all steps of the method according to the first aspect.

In one embodiment of the method according to the first aspect, it is provided that the method is carried out by the system according to the third aspect.

For the purposes of the description, a drone is an unmanned aerial vehicle. A drone is, for example, a quadrocopter, a helicopter, an octocopter, a hexacopter, generally a multicopter.

In one embodiment, it is provided that the method and/or the apparatus and/or the system and/or the storage medium and/or the motor vehicle and/or the drone are secure.

“Secure” in the sense of the description means in particular ‘safe’ and ‘secure.’ Although these two English terms are usually translated into German as “sicher,” they nevertheless have a partially different meaning in English.

The term “safe” refers in particular to the topic of accidents and accident prevention. “Safe” therefore means in particular that measures are taken to ensure the correct functioning of the apparatus and/or the system and/or the storage medium and/or the execution of the process steps.

The term “secure” is directed in particular to the topic of computer protection and hacker protection, i.e., in particular: how secure are the apparatus and/or the storage medium and/or the system and its components against unauthorized access and against data manipulation by third parties, so-called “hackers”? A method and/or the storage medium and/or an apparatus and/or a system which are “secure” therefore have appropriate and sufficient computer protection and hacker protection, in particular as a basis for carrying out the method steps and for the functionality of the apparatus and/or the system.

Secure means, for example, that one or more security conditions are met.

For example, it is intended that one, multiple or all components, for example the motor vehicle and/or the drone, which are involved in carrying out the method and/or which are comprised by the apparatus and/or which are comprised by the system, and/or the storage medium are secure, i.e. for example fulfill one or more security conditions.

This will in particular bring about the technical advantage that the system and/or the method and/or the apparatus and/or the storage medium are secure within the meaning of the description, i.e., in particular secure within the meaning of the English terms “safe” and “secure.”

In one embodiment, it is provided that the one or more security conditions are each an element selected from the following group of security conditions: presence of a predetermined minimum ASIL and/or minimum SIL for at least one of the components, presence of redundancy for at least one of the components, presence of diversity for at least one of the components, presence of at least one plan which includes measures for reducing errors and/or measures in the event of failures of at least one of the components and/or which includes measures for error analysis and/or which includes measures in the event of misinterpretations, presence of one or more fallback scenarios.

This has the technical advantage, for example, that particularly suitable safety conditions are provided.

The abbreviation “ASIL” stands for the English term “Automotive Safety Integrity Level,” which can be translated into German as “Automotive Sicherheitsintegritätslevel.” “Automotive Safety Integrity Level” is a key component of the ISO 26262 standard. ASIL distinguishes between four different ASIL risk levels, which are labeled ASIL-A, ASIL-B, ASIL-C and ASIL-D.

The abbreviation “SIL” stands for the English term “Safety Integrity Level,” which can be translated into German as “Sicherheitsintegritätslevel.” “Safety Integrity Level” is a key component of the IEC EN 61508 standard. SIL distinguishes between four different SIL risk levels, which are labeled SIL-1, SIL-2, SIL-3, and SIL-4.

In one embodiment of the method, it is provided that one, multiple or all steps of the method are only carried out if one or more safety conditions, in particular one or more of the above safety conditions, are fulfilled. For example, the method is only carried out if the one or more safety conditions are fulfilled.

In one embodiment of the method, it is provided that the environmental signals include environmental signals transmitted by a traffic control center. This has the technical advantage, for example, that particularly suitable environmental signals can be used for generating the control signals and/or for analyzing the monitoring data. According to this embodiment, the additional knowledge about the environment of the motor vehicle is therefore provided by a traffic control center. This usually has up-to-date knowledge about the environment of the motor vehicle, which, for example, has not yet been entered into a digital map of the environment. For example, the traffic control center knows the position of a newly established construction site that is not yet recorded on the digital map. For example, the traffic control center knows that a roadwork site that is shown on a digital map no longer exists or has changed its position. This knowledge is represented by the environmental signals.

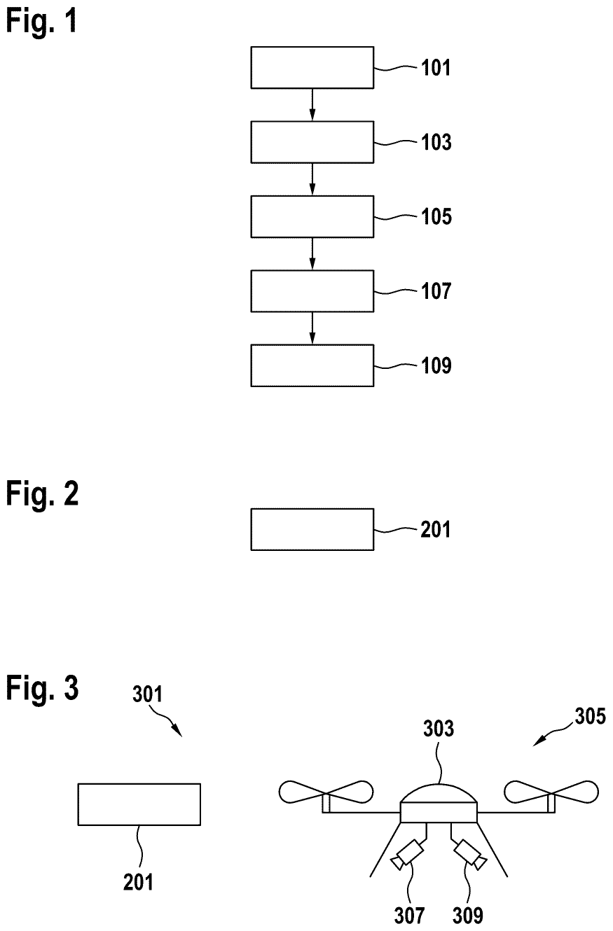

FIG. 1 shows a flowchart of a method for finding an emergency parking position for safe parking of a motor vehicle in an emergency using at least one drone comprising a monitoring facility, comprising the following steps:
generating 101 control signals for controlling the at least one drone such that, when the drone is controlled based on the generated control signals, the at least one drone monitors an environment of the motor vehicle using its monitoring facility and outputs monitoring data based on the monitoring,
outputting 103 the generated control signals in order to control the at least one drone based on the generated control signals,
after outputting the generated control signals, receiving 105 the monitoring data from the at least one drone,
analyzing 107 the monitoring data to find an emergency parking position for safely parking the motor vehicle in an emergency, and
outputting 109 an analysis result of the analysis of the surveillance data.

In one embodiment of the method, it is provided that the motor vehicle is an at least partially automated guided motor vehicle.

In one embodiment of the method, it is provided that the method comprises a step of safely parking the motor vehicle in a found emergency parking position.

According to one embodiment of the method, safe parking comprises at least partially automated guided safe parking.

FIG. 2 shows an apparatus 201. The apparatus 201 is configured to carry out all steps of the method according to the first aspect.

According to an embodiment, the apparatus 201 comprises an input which is configured to receive the signals and/or data described in the description. According to an embodiment, the apparatus 201 comprises one or more processors which are arranged to carry out the steps of analyzing and/or processing and/or determining described in the description. According to an embodiment, the apparatus 201 comprises an output which is configured to output the signals and/or data described in the description. For example, the apparatus 201 comprises the input, the processor(s), and the output. The input comprises, for example, a wireless communication interface. The output comprises, for example, a wireless communication interface. For example, the input and the output are identical. For example, the apparatus 201 comprises a wireless communication interface for bidirectional communication, i.e., for receiving and transmitting the signals and/or data described in the description. The apparatus 201 may, for example, be implemented in a drone used for the method according to the first aspect.

FIG. 3 shows a system 301 for finding an emergency parking position for safe parking of a motor vehicle in an emergency. The system 301 comprises the apparatus 201 according to FIG. 2.

The system 301 comprises a drone 303. The drone 303 comprises a monitoring facility 305. The monitoring facility 305 comprises a first video camera 307 and a second video camera 309, which each comprise an image sensor as an environmental sensor. In an embodiment, the monitoring facility 305 comprises further environmental sensors in addition to or instead of one or both video cameras 307, 309. In an embodiment, the system 301 comprises multiple drones, which are, for example, identical or, for example, different.

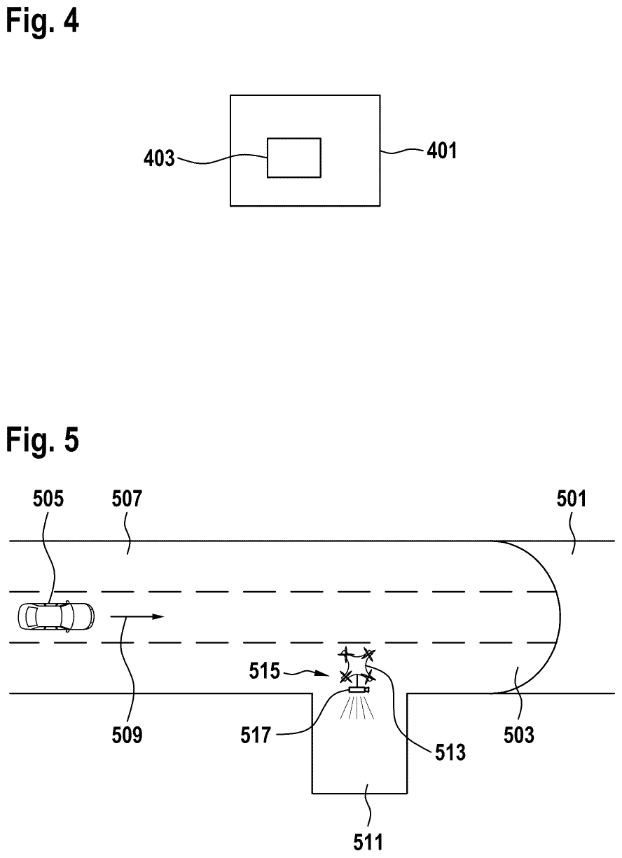

FIG. 4 shows a machine-readable storage medium 401 on which a computer program 403 is stored. The computer program 403 comprises instructions which, when the computer program 403 is executed by a computer, cause the computer to execute a method according to the first aspect. In an embodiment, the machine-readable storage medium 401 is a non-transitory computer-readable medium.

FIG. 5 shows a tunnel 501 as an example of a critical location referred to in the description. The tunnel 501 comprises a tunnel entrance 503.

A motor vehicle 505, which is for example an at least partially automated motor vehicle, drives on a road 507 in the direction of the tunnel entrance 503. A direction of travel of the motor vehicle 505 is indicated by an arrow with the reference sign 509. The direction of travel 509 of the motor vehicle 505 runs from left to right in relation to the paper plane.

The road 507 has a stopping bay 511, which is located in front of the tunnel entrance 503.

A drone 513 comprising a monitoring facility 515 is provided, wherein the monitoring facility 515 has a video camera 517 comprising an image sensor not shown.

The drone 513 can, for example, be controlled in such a way that it detects the occupancy status of the holding bay 511 so that it is known whether the holding bay 511 is occupied or free. This information can, for example, be transmitted to the motor vehicle 505 so that it can plan appropriate measures before an emergency occurs. If, for example, the stopping bay 511 is occupied, the motor vehicle 505 knows that it does not even have to drive to the stopping bay 511 in an emergency, but that alternative emergency parking positions must be found.

The drone 513 can, for example, be controlled in such a way that it searches for further suitable emergency parking positions for the motor vehicle 505. A result of this search, i.e., the analysis result, can for example be transmitted wirelessly to the motor vehicle 505.

According to one embodiment of the method, the analysis result comprises the determined hazard level.

According to one embodiment of the method, the analysis result comprises a result of checking whether the motor vehicle can be parked in the found emergency parking position due to its dimension or dimensions.

According to one embodiment of the method, the analysis result comprises a result of testing whether a found emergency parking position can be approached by the motor vehicle.

According to one embodiment of the method, the analysis result comprises a result of testing whether the found emergency parking position can be approached by the motor vehicle in an at least partially automated manner despite the error in the at least partially automated driving function.

The emergency route signals are transmitted to the motor vehicle according to one embodiment of the method. In one embodiment of the method, it is provided that the optimum emergency parking position is transmitted to the motor vehicle.

In one embodiment of the method, it is provided that the motor vehicle sends the route signals to the infrastructure. In particular, this means that these route signals are received by the infrastructure from the motor vehicle. Thus, the route signals can, for example, be used by the infrastructure for analyzing the monitoring data and/or for generating the control signals.

In one embodiment of the method, it is provided that the infrastructure assistance data is determined based on the emergency route and/or based on the route signals.

In one embodiment of the method, it is provided that the motor vehicle control signals are generated based on the emergency route signals.

In summary, in particular a concept is provided according to which one or more drones, each comprising a monitoring facility, are used to search for one or more emergency parking positions suitable for the motor vehicle in the environment of the motor vehicle, in particular in the environment of the motor vehicle which is located in front of the motor vehicle in the direction of travel of the motor vehicle. This search is carried out in particular in an emergency, for example in the event of a fault, for example in the event of a fault in an at least partially automated driving function of the motor vehicle. This allows the motor vehicle to be parked safely and efficiently in an emergency.

1. A method for finding an emergency parking position for safe parking of a motor vehicle, comprising:
generating a plurality of control signals for controlling a drone having a monitoring facility;
outputting the control signals to control the drone to monitor an environment of the motor vehicle using the monitoring facility and to output a monitoring data based on the monitoring; and
after outputting the control signals, receiving the monitoring data from the drone, analyzing the monitoring data to find an emergency parking position for safe parking of the motor vehicle in an emergency, and outputting an analysis result of the analysis of the monitoring data.

2. The method of claim 1, wherein analyzing the monitoring data comprises determining a hazard level for a found emergency parking position, the hazard level indicates how endangered the motor vehicle would be in the found emergency parking position and/or how endangered an environment of the found emergency parking position would be if the motor vehicle were parked in the found emergency parking position.

3. The method of claim 1, wherein a plurality of dimension signals are received which represent one or more dimensions of the motor vehicle, the monitoring data is analyzed based on the dimension signals, and the analyzing comprises that a found emergency parking position is checked as to whether the motor vehicle can be parked in the found emergency parking position based on the one or more dimensions.

4. The method of claim 1, wherein the analyzing comprises checking that a found emergency parking position can be approached by the motor vehicle.

5. The method of claim 4, wherein a plurality of error signals are received which represent an error in an at least partially automated driving function of the motor vehicle, the monitoring data is analyzed based on the error signals, and the analyzing comprises checking whether, despite the error in the at least partially automated driving function, the found emergency parking position can be approached by the motor vehicle in the at least partially automated manner.

6. The method of claim 1, wherein a plurality of emergency route signals are generated which represent an emergency route from a start position to a found emergency parking position for the motor vehicle, the emergency route signals are output.

7. The method of claim 1, wherein the analyzing comprises determining an optimum emergency parking position when a plurality of emergency parking positions are found.

8. The method of claim 1, wherein a plurality of route signals are received which represent a current route of the motor vehicle, the control signals are generated based on the route signals and/or the monitoring data is analyzed based on the route signals.

9. The method of claim 1, wherein a plurality of environmental signals are received which represent the environment of the motor vehicle, the control signals are generated based on the environmental signals and/or the monitoring data is analyzed based on the environmental signals.

10. The method of claim 9, wherein the environmental signals include a plurality of signals transmitted by another motor vehicle located in front of the motor vehicle with respect to a direction of travel of the motor vehicle.

11. The method of claim 9, wherein the environmental signals include a plurality of signals transmitted by a traffic control center.

12. The method of claim 1, wherein the method is only started in an emergency or the method is started proactively before an emergency occurs.

13. The method of claim 1, wherein, based on the analysis result, an infrastructure assistance data for an infrastructure-supported assistance of the motor vehicle during an at least partially automated guided journey to a found emergency parking position is determined and transmitted to the motor vehicle.

14. The method of claim 1, wherein the control signals are generated such that, when controlling the drone based on the control signals, the monitoring of the environment comprises monitoring a road traffic in the environment of the motor vehicle.

15. The method of claim 1, wherein the monitoring data and/or the analysis result are transmitted to a traffic control center.

16. The method of claim 1, wherein, in the emergency, a message is transmitted to one or more road users in a vicinity of the motor vehicle, informing about the emergency and/or about a found emergency parking position and/or about an operation of parking the motor vehicle at the found emergency parking position.

17. The method of claim 1, wherein the control signals are generated such that, when controlling the drone based on the control signals, the monitoring of the environment comprises live monitoring of the environment of the motor vehicle such that the monitoring data comprises live monitoring data.

18. The method of claim 1, wherein one, more or all steps of the method are performed only when one or more safety conditions are met.

19. An apparatus comprising a processor performing the steps of:
generating a plurality of control signals for controlling a drone having a monitoring facility;
outputting the control signals to control the drone to monitor an environment of a motor vehicle using the monitoring facility and to output a monitoring data based on the monitoring; and
after outputting the control signals, receiving the monitoring data from the drone, analyzing the monitoring data to find an emergency parking position for safe parking of the motor vehicle in an emergency, and outputting an analysis result of the analysis of the monitoring data.

20. A system for finding an emergency parking position for safe parking of a motor vehicle, comprising:
a drone having a monitoring facility; and
an apparatus comprising a processor performing the steps of:
generating a plurality of control signals for controlling the drone;
outputting the control signals to control the drone to monitor an environment of the motor vehicle using the monitoring facility and to output a monitoring data based on the monitoring; and
after outputting the control signals, receiving the monitoring data from the drone, analyzing the monitoring data to find an emergency parking position for safe parking of the motor vehicle in an emergency, and outputting an analysis result of the analysis of the monitoring data.
